(19) United States
(12) Patent Application Publication
(10) Pub. No.: US 2015/0022510 A1
(43) Pub. Date: Jan. 22, 2015

(54) ARRAY SUBSTRATE AND LIQUID CRYSTAL PANEL WITH THE SAME

(71) Applicant: Shenzhen China Star Optoelectronics Technology Co., Ltd., Shenzhen, Guangdong (CN)

(72) Inventors: Xiaohui Yao, Shenzhen City (CN); Je-hao Hsu, Shenzhen City (CN); Juanning Dang, Shenzhen City (CN)

(73) Assignee: Shenzhen China Star Optoelectronics Technology Co., Ltd., Shenzhen, Guangdong (CN)

(21) Appl. No.: 13/985,796

(22) PCT Filed: Jul. 24, 2013
(86) PCT No.: PCT/CN2013/080001

§ 371 Date: Aug. 15, 2013

(30) Foreign Application Priority Data
Jul. 19, 2013 (CN) 2013103073832

(51) Int. Cl. G09G 3/36

(52) U.S. Cl. CPC G09G 3/3659; G09G 3/3677; G09G 3/3688
USPC 345/211; 345/92

(57) ABSTRACT

An array substrate and a liquid crystal panel are disclosed. Each of the pixel cells in the array substrate includes a first pixel electrode, a second pixel electrode, and a third pixel electrode. The third pixel electrode connects to the second pixel electrode via a third transistor. In the 2D display mode, the third transistor is turn on such that the second pixel electrode and the third pixel electrode are electrically connected. At this moment, the three pixel electrodes are in the displaying state of corresponding 2D images. The voltage of the second pixel electrode is changed due to the voltage of the third pixel electrode. In the 3D display mode, the second pixel electrode and the third pixel electrode are not electrically connected such that the third pixel electrode is in the displaying state of the black images.

### BACKGROUND OF THE INVENTION

1. Field of the Invention

The present disclosure relates to liquid crystal display technology, and more particularly to an array substrate and a liquid crystal panel with the same.

2. Discussion of the Related Art

LCDs typically are characterized by attributes including thin, saturated colors, and stable display without flash, which are achieved by utilizing physical structures and optical characteristics of liquid crystal. Different liquid crystal alignments result in different reflective rates in different viewing angles. Specifically, the light transmission rates are different while the viewing angles are different and thus color distortion may occur in a wide viewing angle.

With the technology evolution, most LCDs are capable of displaying 2D mode and 3D mode. In 3D Film-type Patterned Retarder (FPR) technology, pixels arranged in two adjacent rows respectively corresponds to the left eye and the right eye so as to generate the signals for left eye image and the right eye image. The left eye image and the right eye image are received by viewers' eyes and then integrated by viewers' brain to obtain the 3D effect. When the left eye image and the right eye image are both received by viewer's left eye and right eye, the cross talk effect occurs. In order to reduce the cross talk effect, as shown in FIG 1, a black matrix (BM) arranged between the pixels arranged in two adjacent rows is adopted. Such solution may greatly decrease the aperture rate in the 2D display mode and the brightness is affected.

### SUMMARY

The object of the invention is to provide an array substrate and a liquid crystal display with the same. The array substrate not only increases the aperture rate in the 2D display mode, but also decreases the color shift in the 3D display mode. In addition, the cross talk effect is also reduced in 3D display mode.

In one aspect, an array substrate includes: a plurality of first scanning lines, a plurality of second scanning lines, and a plurality of pixel cells arranged along a row direction, and a plurality of data lines, and each the pixel cells corresponds to one first scanning line, one second scanning line, and one data line; each of the pixel cells include a first pixel electrode, a second pixel electrode, a third pixel electrode, a first transistor, a second transistor, and a third transistor, the first pixel electrode connects to the corresponding first scanning line and the corresponding data line via the first transistor, the second pixel electrode connects to the corresponding first scanning line and the corresponding data line via the second transistor, the third pixel electrode connects to the corresponding second scanning line and the second pixel electrode via the third transistor; in a 2D display mode, the first scanning line inputs scanning signals to turn on the first transistor and the second transistor, the first pixel electrode and the second pixel electrode receive the data signals from the data lines so as to be in a displaying state of corresponding 2D images, the second scanning line inputs the scanning signals to turn on the third transistor such that the second pixel electrode and the third pixel electrode are electrically connected, the third pixel electrode receives the data signals from the second pixel electrode so as to be in the displaying state of corresponding 2D images, the voltage of the second pixel electrode is changed due to the third pixel electrode, the third transistor is a thin film transistor (TFT), a width/length ratio of the third transistor is configured to be smaller than a predetermined value such that a voltage difference between the second pixel electrode and the third pixel electrode is not zero when the third transistor is turn on, and wherein a scanning process of the corresponding first scanning line of a current pixel-cell row and that of the corresponding second scanning line of a previous pixel-cell begin at the same time, and the previous pixel-cell row is adjacent to the current pixel-cell row and is recently scanned; and in a 3D display mode, the first scanning line input scanning signals to turn on the first transistor and the second transistor, the first pixel electrode and the second pixel electrode receive the data signals from the data line so as to be in the displaying state of corresponding 3D images, and the second scanning line turns off the third transistor such that: the third pixel electrode is in the displaying state of corresponding black images.

Wherein the array substrate further include a switch unit arranged in a periphery of the array substrate and a shorting line, the switch unit include a plurality of transistors, each of the transistors include a control end, an input end and an output end, each input end of the transistors connects to the corresponding first scanning lines of the current pixel-cell row, each output end of the transistors connects to the corresponding second scanning line of the previous pixel-cell row, the previous pixel-cell row is adjacent to the current pixel-cell row, and each control ends of the transistors connects to the shorting line; and in the 2D display mode, the shorting line input the control signals to turn on all of the transistors of the switch unit, the scanning signals input by the corresponding first scanning of the current pixel-cell row are simultaneously input to the second scanning line connected to the output end of the corresponding transistor to turn on the third transistor, and in the 3D display mode, the shorting line inputs the control signals to turn off the transistors of the switch unit.

Wherein a dimension of the third pixel electrode is smaller than the dimension of the first pixel electrode and the second pixel electrode.

In another aspect, an array substrate includes: a plurality of first scanning lines, a plurality of second scanning lines, a plurality of data lines, and a plurality of pixel cells, and each the pixel cells corresponds to one first scanning line, one second scanning line, and one data line; each of the pixel cells include a first pixel electrode, a second pixel electrode, a third pixel electrode, a first transistor, a second transistor, and a third transistor, the first pixel electrode connects to the corresponding first scanning line and the corresponding data line via the first transistor, the second pixel electrode connects to the corresponding first scanning line and the corresponding data line via the second transistor, the third pixel electrode connects to the corresponding second scanning line and the second pixel electrode via the third transistor; in a 2D display mode, the first scanning line inputs scanning signals to turn on the first transistor and the second transistor, the first pixel electrode and the second pixel electrode receive the data signals from the data lines so as to be in a displaying state of corresponding 2D images, the second scanning line inputs the scanning signals to turn on the third transistor such that the second pixel electrode and the third pixel electrode are electrically connected, the third pixel electrode receives the data signals from the second pixel electrode so as to be in the displaying state of corresponding 2D images, the voltage of the second pixel electrode is changed due to the third pixel electrode, the third pixel electrode receives the data signals from the second pixel electrode so as to be in a displaying state of the corresponding 2D images, the voltage of the second pixel electrode is changed due to the third pixel electrode. and a voltage difference between the second pixel electrode and the third pixel electrode is not zero when the third transistor is turn on; and in a 3D display mode, the first scanning line input scanning signals to turn on the first transistor and the second transistor, the first pixel electrode and the second pixel electrode receive the data signals from the data line so as to be in the displaying state of corresponding 3D images, and the second scanning line turns off the third transistor such that the third pixel electrode is in the displaying state of corresponding black images.

Wherein the plurality of pixel electrodes, first scanning lines, second scanning lines are arranged along a row direction, in the 2D display mode, and a scanning process of the corresponding first scanning line of a current pixel-cell row and that of the corresponding second scanning line of a previous pixel-cell begin at the same time, and the previous pixel-cell row is adjacent to the current pixel-cell row is recently scanned.

Wherein the array substrate further include a switch unit arranged in a periphery of the array substrate and a shorting line, the switch unit include a plurality of transistors, each of the transistors include a control end, an input end and an output end, each input end of the transistors connects to the corresponding first scanning lines of the current pixel-cell row, each output end of the transistors connects to the corresponding second scanning line of the previous pixel-cell row, the previous pixel-cell row is adjacent to the current pixel-cell row, and each control ends of the transistors connects to the shorting line; and in the 2D display mode, the shorting line input the control signals to turn on all of the transistors of the switch unit, the scanning signals input by the corresponding first scanning of the current pixel-cell row are simultaneously input to the second scanning line connected to the output end of the corresponding transistor to turn on the third transistor, and in the 3D display mode, the shorting line inputs the control signals to turn off the transistors of the switch unit.

Wherein a dimension of the third pixel electrode is smaller than the dimension of the first pixel electrode and the second pixel electrode.

Wherein the third transistor is a thin film transistor (TFT), a width/length ratio of the third transistor is configured to be smaller than a predetermined value such that a voltage difference between the second pixel electrode and the third pixel electrode is not zero.

In one aspect, a liquid crystal panel includes: an array substrate, a color filtering substrate and a liquid crystal layer between the array substrate and the color filtering substrate. The array substrate includes: a plurality of first scanning lines, a plurality of second scanning lines, a plurality of data lines, and a plurality of pixel cells, and each the pixel cells corresponds to one first scanning line, one second scanning line, and one data line; each of the pixel cells include a first pixel electrode, a second pixel electrode, a third pixel electrode, a first transistor, a second transistor, and a third transistor, the first pixel electrode connects to the corresponding first scanning line and the corresponding data line via the first transistor, the second pixel electrode connects to the corresponding first scanning line and the corresponding data line via the second transistor, the third pixel electrode connects to the corresponding second scanning line and the second pixel electrode via the third transistor; in a 2D display mode, the first scanning line inputs scanning signals to turn on the first transistor and the second transistor, the first pixel electrode and the second pixel electrode receive the data signals from the data lines so as to be in a displaying state of corresponding 2D images, the second scanning line inputs the scanning signals to turn on the third transistor such that the second pixel electrode and the third pixel electrode are electrically connected, the third pixel electrode receives the data signals from the second pixel electrode so as to be in the displaying state of corresponding 2D images, the voltage of the second pixel electrode is changed due to the third pixel electrode, the third pixel electrode receives the data signals from the second pixel electrode so as to be in a displaying state of the corresponding 2D images, the voltage of the second pixel electrode is changed due to the third pixel electrode, and a voltage difference between the second pixel electrode and the third pixel electrode is not zero when the third transistor is turn on; and in a 3D display mode, the first scanning line input scanning signals to turn on the first transistor and the second transistor, the first pixel electrode and the second pixel electrode receive the data signals from the data line so as to be in the displaying state of corresponding 3D images, and the second scanning line turns off the third transistor such that the third pixel electrode is in the displaying state of corresponding black images.

Wherein the plurality of pixel electrodes, first scanning lines, second scanning lines are arranged along a row direction, in the 2D display mode, and a scanning process of the corresponding first scanning line of a current pixel-cell row and that of the corresponding second scanning line of a previous pixel-cell begin at the same time, and the previous pixel-cell row is adjacent to the current pixel-cell row and is recently scanned.

Wherein the array substrate further include a switch unit arranged in a periphery of the array substrate and a shorting line, the switch unit include a plurality of transistors, each of the transistors include a control end, an input end and an output end, each input end of the transistors connects to the corresponding first scanning lines of the current pixel-cell row, each output end of the transistors connects to the corresponding second scanning line of the previous pixel-cell row, the previous pixel-cell row is adjacent to the current pixel-cell row, and each control ends of the transistors connects to the shorting line; and in the 2D display mode, the shorting line input the control signals to turn on all of the transistors of the switch unit, the scanning signals input by the corresponding first scanning of the current pixel-cell row are simultaneously input to the second scanning line connected to the output end of the corresponding transistor to turn on the third transistor, and in the 3D display mode, the shorting line inputs the control signals to turn of the transistors of the switch unit.

Wherein a dimension of the third pixel electrode is smaller than the dimension of the first pixel electrode and the second pixel electrode.

Wherein the third transistor is a thin film transistor (TFT), a width/length ratio of the third transistor is configured to be smaller than a predetermined value such that a voltage difference between the second pixel electrode and the third pixel electrode is not zero.

### BRIEF DESCRIPTION OF THE DRAWINGS

FIG. 1 is a schematic view of the array substrate in accordance with a first embodiment.

FIG. 2 is a schematic view of the pixel cell of FIG. 1.

FIG. 3 is an equivalent-circuit diagram of the pixel cell of FIG 1.

FIG. 4 is a schematic view showing the display performance of the third pixel electrode of FIG. 1 in the 3D display mode.

FIG. 5 is an equivalent-circuit diagram of the pixel cell in accordance with a second embodiment.

FIG. 6 is a schematic view of the liquid crystal panel in accordance with one embodiment.

### DETAILED DESCRIPTION OF THE EMBODIMENTS

Embodiments of the invention will now be described more fully hereinafter with reference to the accompanying drawings, in which embodiments of the invention are shown.

In order to overcome the color distortion problem in wide viewing angle, usually, the pixels are divided to a plurality of pixel areas. By applying different voltages to the pixel areas, the alignment of the liquid crystal in the two areas are different such that the low color shirt (LCS) effect is achieved.

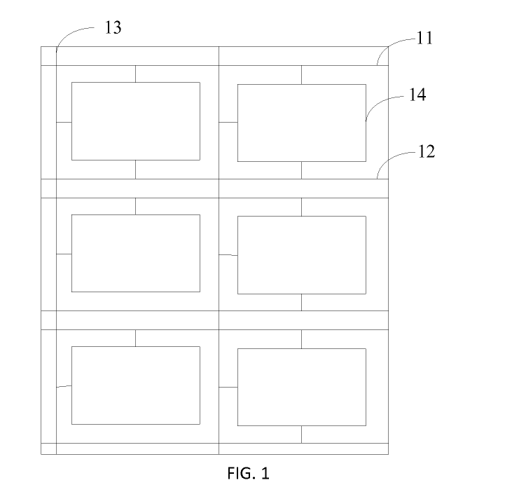

FIG. 1 is a schematic view of the array substrate in accordance with a first embodiment. The array substrate includes a plurality of first scanning lines 11, a plurality of second scanning lines 12, a plurality of data lines 13, and a plurality of pixel cells 14. The pixel cells 14 are arranged in a matrix form. Each of the pixel cells 14 connects to one first scanning line 11, one second scanning line 12, and one data line 13.

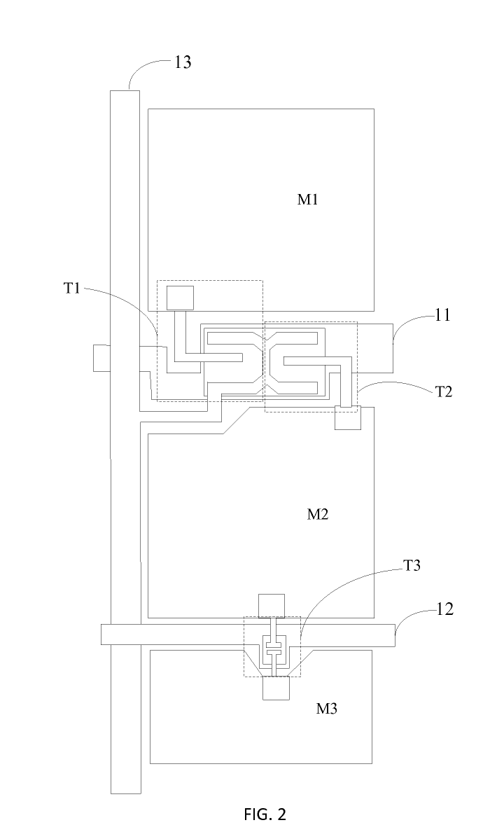

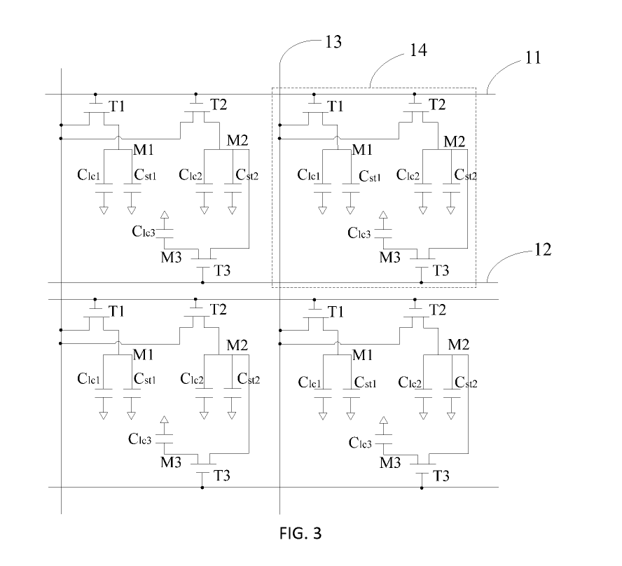

Referring to FIGS. 2 and 3, each of the pixel cells 14 includes a first pixel electrode M1, a second pixel electrode M2, a third pixel electrode M3, a first transistor T1, a second transistor T2, and a third transistor T3. The first transistor T1, the second transistor T2, and the third transistor T3 respectively corresponds to the first pixel electrode M1, the second pixel electrode M2, and the third pixel electrode M Control ends of the first transistor T1 and the second transistor T2 electrically connect to the first scanning lines 11. Input ends of the first transistor T1 and the second transistor T2 electrically connect to the data lines 13. An output end of the first transistor T1 electrically connects to the first pixel electrode M1, and the output end of the second transistor T2 electrically connects to the second pixel electrode M2. The control end of the third transistor T3 electrically connects to the second scanning line 12. The input end of the third transistor T3 electrically connects to the second pixel electrode M2. The output end of the third transistor T3 electrically connects to the third pixel electrode M3.

In one embodiment, the first transistor T1, the second transistor T2, and the third transistor T3 are thin film transistors (TFTs). The control ends of the T1, T2, T3 correspond to the gate of the TFT, the input ends of the T1, T2, T3 correspond to the source of the TFT, and the output ends of the T1, T2, T3 correspond to the drain of the TFT. In other embodiments, the three transistors may be triodes or Darlington transistors.

The array substrate not only increases the aperture rate in the 2D display mode, but also decreases the color shift in the 2D display mode and the cross talk effect in the 3D display mode.

In the 2D display mode, the first scanning line 11 and the second scanning line 12 are scanned in a row-by-row manner. The first scanning lines 11 input high-level scanning signals to turn on the first transistor T1 and the second transistor T2. The data line 13 inputs data signals. The first pixel electrode M1 and the second pixel electrode M2 receive the data signals from the data line 13 such that the voltage of the first pixel electrode M1 and the second pixel electrode M2 are the same. As a result, the first pixel electrode M1 and the second pixel electrode M2 are in a displaying state of corresponding 2D images. Afterward, the first scanning line 11 stops inputting the high-level scanning signals. The second scanning line 12 inputs the high-level scanning signals to turn on the third transistor T3. At this moment, the second pixel electrode M2 and the third pixel electrode M3 are electrically connected such that the data signals stored in the second pixel electrode M2 are input to the third pixel electrode M3 via the third transistor T1. In this way, the third pixel electrode M3 is also in the displaying state of corresponding 2D images. In view of the above, in the 2D display mode, the first pixel electrode M1, second pixel electrode M2, and the third pixel electrode M3 are all in the displaying state of corresponding 2D images such that the aperture rate in the 2D display mode is increased. In addition, when the third transistor T3 is turn on, the voltage of the second pixel electrode M2 is changed due to the third pixel electrode M3. That is, the voltage of the second pixel electrode M2 is changed due to the charge sharing between the liquid crystal capacitor Clc3 and the second pixel electrode M2. The liquid crystal capacitor Clc3 is an equivalent capacitor formed by the liquid crystal between the third pixel electrode M3 and the common electrode of another substrate.

Specifically, when the data signals are greater than the common voltage, i.e., the positive polarity is reversed, some charges of the second pixel electrode M2 are transferred to the third pixel electrode M3 such that the voltage of the second pixel electrode M2 is decreased and that of the third pixel electrode M3 is increased. Thus, the voltage of the second pixel electrode M2 is different from that of the first pixel electrode M1, that is, the voltage difference of the second pixel electrode M2 and the first pixel electrode M1 is not zero. When the data signals are smaller than the common voltage, i.e., the negative polarity is reversed, some charges of the third pixel electrode M3 are transferred to the second pixel electrode M2 such that the voltage of the second pixel electrode M2 is increased, and the voltage of the second pixel electrode M2 is different from that of first pixel electrode M1.

When being turn on, the third transistor T3 maintains the voltage difference between the second pixel electrode M2 and the third pixel electrode M3 to be not equal to zero, which means the charging between the second pixel electrode M2 and the third pixel electrode M3 is not balanced. In this way, the voltage of the first pixel electrode M1, the second pixel electrode M2, and the third pixel electrode M3 are different so as to achieve the low color shift in the 2D display mode.

in one embodiment, a width/length ratio of the third transistor T3 is configured to control the voltage different between the second pixel electrode M2 and the third pixel electrode M3 when the third transistor T3 is turn on. That is, the width/length ratio of the third transistor T3 is configured to control a current amount of the third transistor T3. The greater width/length ratio of the third pixel electrode M3 relates to the greater current amount and a faster speed of charges transfer between the second pixel electrode M2 and the third pixel electrode M3. To ensure the voltage of the second pixel electrode M2 is not the same with that of the third pixel electrode M3 when the third transistor T3 is turn on, the charges transfer speed between the second pixel electrode M2 and the third pixel electrode M3 is configured to slow down, and thus the width/length ratio of the third transistor T3 is smaller than a predetermined value, i.e., 0.3. Under the circumstance, the voltage difference between the second pixel electrode M2 and the third pixel electrode M3 is not zero when the third transistor T3 is turn on. In other embodiments, the current amount of the third transistor T3 is configured by controlling the voltage of the gate of the third transistor T3, for example, controlling the scanning signals input from the second scanning line 12.

After completing the scanning process of the corresponding first scanning lines 11 and the second scanning line 12 of a current pixel-cell row, the corresponding first scanning lines 11 and the second scanning line 12 of the next pixel-cell row begin the scanning process.

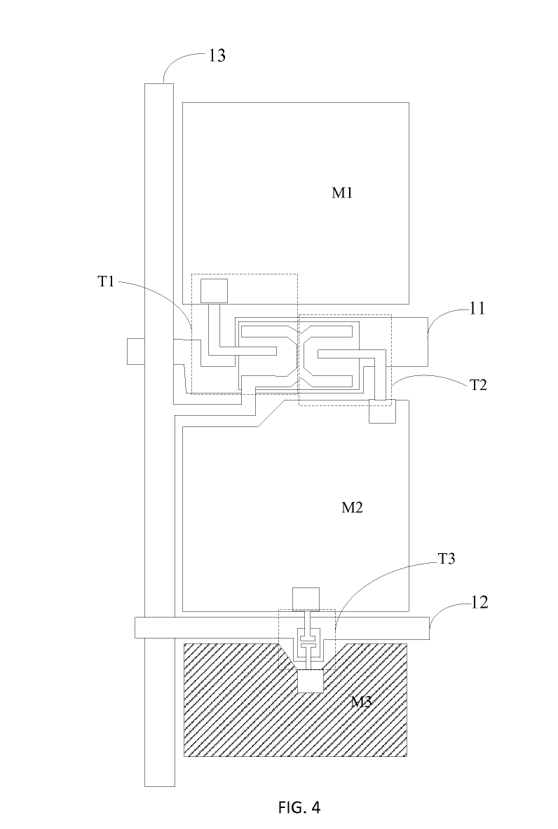

Referring to FIG. 4, in the 3D display mode, firstly, the black images turns of the third pixel electrode M3. That is, the data line 13 input the data signals corresponding to the black images to the first pixel electrode M1 and the second pixel electrode M2. Afterward, the third transistor T3 is turn on and thus the third pixel electrode M3 is in the displaying state of corresponding black images. That is the thud pixel electrode M3 is turn off

The first scanning line 11 inputs high-level scanning signals to turn on the first transistor T1 and the second transistor T2, and the data line 13 inputs the data signals to the first pixel electrode M1 and the second pixel electrode M2 respectively by the first transistor T1 and the second transistor 12 such that the first pixel electrode M1 and the second pixel electrode M2 are in the displaying state of corresponding 3D images. In the 3D display mode, the second scanning line 12 is turn off, that is, the scanning signals are not input to the second scanning line 12. The third transistor T3 is turn off such that the third pixel electrode M3 is maintained in the displaying state of corresponding black images.

In the embodiment, the first pixel electrode M1, the second pixel electrode M2 and the third pixel electrode M3 are arranged along the row direction. Two pixel cells 14 arranged in adjacent rows respectively displays the corresponding left eye image and the right eye image of the 3D images. As shown in FIG. 4, the third transistor T3 is turn off such that the third pixel electrode M3 is in the displaying state of the black images, which is equivalent to a black matrix (BM) between the pixel-cell rows 14 arranged in adjacent rows. The BM is arranged between the second pixel electrode M2 and the third pixel electrode M3 of the current pixel-cell row, which is for displaying the left eye image, and the second pixel electrode M2 and the third pixel electrode M3 of a next pixel-cell row, which is for displaying the right eye image. The BM blocks the cross talk signals of the left eye image and the right eye image so reduced the cross talk effect in the 3D display mode. In one embodiment, the dimension of the third pixel electrode M3 is smaller than that of the first pixel electrode M1 and the second pixel electrode M2. In other embodiments, the dimension of the third pixel electrode M3 is configurable.

In other embodiments, the three pixel electrodes may be arranged along a column direction, and the two adjacent pixel cells arranged along the column direction respectively displays the left eye image and the right eye image of the 3D images. Similarly, the third pixel electrode for displaying corresponding black images is arranged to reduce to cross talk effect in the 3D display mode. In other embodiments, a black insertion method can be adopted within a blanking time of the first scanning line to maintain the third pixel electrode M3 in the displaying state of the black images. Within a scanning time frame, the first pixel electrode and the second pixel electrode are controlled to be in the displaying state of corresponding 3D images, and the third pixel electrode M3 is controlled to be in the displaying state of corresponding black images. In the next scanning time frame, all of the pixel electrodes are in the displaying state of corresponding black images. Afterward, the first pixel electrode, the second pixel electrode, and the second pixel electrode are in the displaying state of corresponding 3D images. In brief, the first pixel electrode and the second pixel electrode alternately display the corresponding 3D images and the black images. The above black insertion method can prevent the second pixel electrode from leaking electricity and the light leakage.

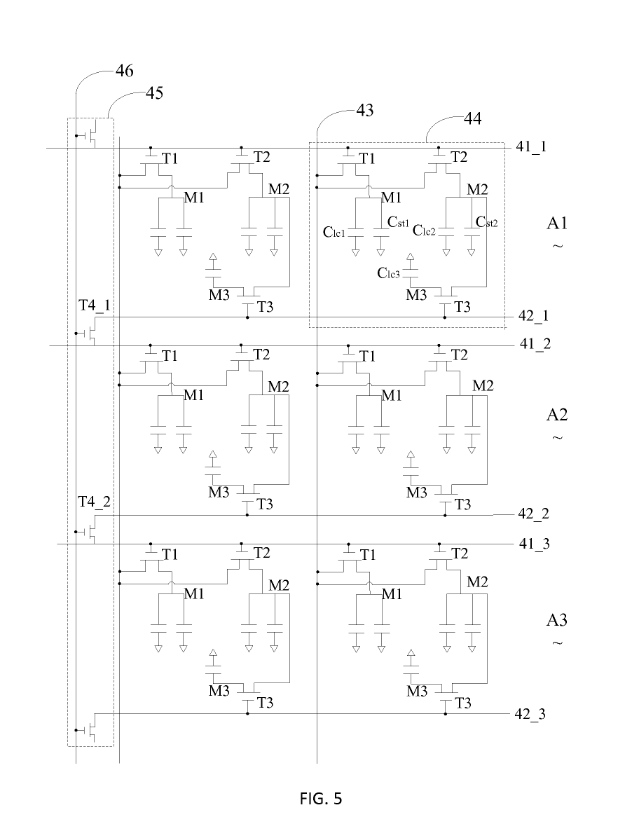

In the above embodiments, in the 2D display mode, the first and the second scanning lines perform the scanning process in the row-by-row basis. In other embodiments, a plurality of rows may be scanned by the corresponding first and the second scanning lines simultaneously. As shown in FIG. 5, a plurality of pixel cells 44, first scanning lines (41_1, 41_2, 41_3), and second scanning lines (42_1, 42_2, 42_3) are arranged along the row direction. One pixel-cell row corresponds to one first scanning line and one second scanning line.

In the 2D display mode, the first pixel cell row A1 and the second pixel-cell row A2 are taken as the example to illustrate. Upon scanning the corresponding first scanning line (41_2) of the second pixel-cell row A2, the corresponding second scanning line (42_1) of the adjacent pixel-cell row that is recently scanned, i.e., the first pixel-cell A1, is also scanned simultaneously.

In one embodiment, the array substrate also includes a switch unit 45 arranged in a periphery of the array substrate and one shorting line 46. The switch unit 45 includes a plurality of transistors. For example, as shown in FIG. 5, the switch unit 45 includes four transistors (T4_1, T4_2). The transistor includes a control end, an input end and an output end. The transistor (T4_1) between the pixel-cell row A1 and the pixel-cell row A2 is taken as one example. The input end of the transistor (T4_1) connects to the first scanning line (41_2) of the second pixel-cell row A2, the output end of the transistor (T4_1) connects to the second scanning line (42_1), and the control ends of all of the transistors connect to the shorting line 46. In one embodiment, the transistors are thin film transistors (TFT). The control end of the transistor corresponds to a gate of the TFT, the input end of the transistor corresponds to a source of the TFT, and the output end of the transistor corresponds to a drain of the TFT.

In the 2D display mode, the shorting line 46 inputs high-level control signals to turn on all of the transistors of the switch unit 45, an then the first scanning lines 41 are scanned in the row-by-row basis. First, the corresponding first scanning line (41_1) of the first pixel-cell row A1 inputs the scanning signals to turn on the first transistor T1 and the t2 and the second transistor 12 of the first pixel-cell row A1. The data line 43 inputs the data signals such that the first pixel electrode M1 and the second pixel electrode M2 are in the displaying state of corresponding 2D images. Afterward, the corresponding first scanning line (41_2) of the second pixel-cell row A2 inputs the scanning signals to turn on the first transistor T1 and the second transistor T2. At the moment, the transistor (14_1) is turn on. The scanning signals input from the first scanning line (41_2) enter the corresponding second scanning line (42_1) of the first pixel-cell row A1 via the transistor (14_1) to turn on the third transistor T3. As such, the second pixel electrode M2 and the third pixel electrode M3 are electrically connected, and the third pixel electrode M3 of the first pixel-cell row A1 is in the displaying state of the corresponding 2D images so as to increase the aperture rate. In addition, the voltage of the second pixel electrode M2 of the first pixel-cell row A1 is changed due to the third pixel electrode M3 such that the voltage of the first pixel electrode M1, the second pixel electrode M2 and the third pixel electrode M3 are different to achieve the low color shift After the corresponding first scanning line (41_2) of the second pixel-cell row A2 has been scanned, the scanning process of the corresponding first scanning line (41_3) of the third pixel-cell row A3 begins. At the same time, the transistor (T4_2) controls the corresponding second scanning line (42_2) of the second pixel-cell row A2 to be scanned simultaneously. It is to be noted that the scanning process are similarly performed for all of the other scanning lines.

In the 3D display process, the shorting line 46 inputs the control signals to turn off the transistors of the switch unit 45. The scanning signals input from the first scanning line 41_1 to turn on the first transistor T1 and the second transistor T2 of the first pixel-cell row A1. The data line 43 inputs the data signals such that the first pixel electrode M1 and the second pixel electrode M2 of the first pixel-cell row A1 are in the displaying state of the corresponding 3D images. Afterward, the scanning signals are input to the corresponding first scanning line (41_2) of the second pixel-cell row A2 to turn on the first transistor T1 and the second transistor T2. As the transistor (T4_1) is turn off, and thus the scanning signals input from the first scanning line (41_2) would not enter the third transistor T3 of the first pixel-cell row A1 such that the third transistor T3 is turn off. As such, the third pixel electrode M3 of the first pixel-cell row A1 is in the displaying state of the corresponding black image to reduce the cross talk effect in the 3D display mode. After the corresponding first scanning line (41_2) of the second pixel-cell row A2 has been scanned, the scanning process of the corresponding first scanning line (41_3) of the next pixel-cell row A3 begins. It is to be noted that the transistor T4 is in the off state all the time.

In view of the above, only one scanning driven chip is needed to apply the control signals to turn on or off the transistors of the switch unit 45. As such, the third transistor T3 is controlled to be turn on or off. In this way, not only the low color shift effect and a higher aperture rate can be achieved in the 2D display mode, but also the cross talk effect can be reduced in the 3D display mode. Furthermore, the number of the scanning driven chips can also be reduced, and so does the cost. On the other hand, two scanning lines can be scanned within the same scanning time frame such that the scanning time of each of the scanning line is prolonged, which contributes to a higher refresh rate.

In other embodiments, the plurality of pixel cells, the first scanning lines and the second scanning lines are arranged along the column direction. Also, the corresponding scanning lines of two adjacent pixel-cell columns, which relate to a current pixel-cell column and the pixel-cell column that is recently scanned, can be scanned at the same time by adopting the above switch unit 45 and the shorting line 46. In other embodiments, each of the scanning line independently connects to one scanning driven chip such that the scanning lines can be scanned at the same time.

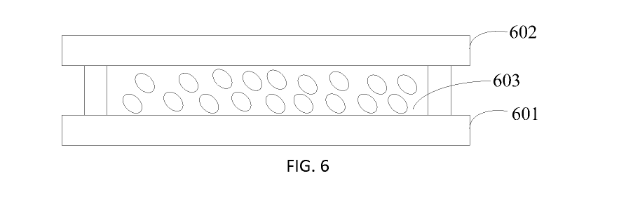

FIG. 6 is a schematic view of the liquid crystal panel in accordance with one embodiment. The liquid crystal panel includes the array substrate 601, a color filtering substrate 602, and a liquid crystal layer 603 between the array substrate 601 and the color filtering substrate 602.

It is believed that the present embodiments and their advantages will be understood from the foregoing description, and it will be apparent that various changes may he made thereto without departing from the spirit and scope of the invention or sacrificing all of its material advantages, the examples hereinbefore described merely being preferred or exemplary embodiments of the invention.

What is claimed is:

1. An array substrate, comprising:
a plurality of first scanning lines, a plurality of second scanning lines, and a plurality of pixel cells arranged along a row direction, and a plurality of data lines, and each the pixel cells corresponds to one first scanning line, one second scanning line, and one data line;
each of the pixel cells comprises a first pixel electrode, a second pixel electrode, a third pixel electrode, a first transistor, a second transistor, and a third transistor, the first pixel electrode connects to the corresponding first scanning line and the corresponding data line via the first transistor, the second pixel electrode connects to the corresponding first scanning tine and the corresponding data line via the second transistor, the third pixel electrode connects to the corresponding second scanning line and the second pixel electrode via the third transistor;
in a 2D display mode, the first scanning line inputs scanning signals to turn on the first transistor and the second transistor, the first pixel electrode and the second pixel electrode receive the data signals from the data lines so as to be in a displaying state of corresponding 2D images, the second scanning line inputs the scanning signals to turn on the third transistor such that the second pixel electrode and the third pixel electrode are electrically connected, the third pixel electrode receives the data signals from the second pixel electrode so as to be in the displaying state of corresponding 2D images, the voltage of the second pixel electrode is changed due to the third pixel electrode, the third transistor is a thin film transistor (TFT), a width/length ratio of the third transistor is configured to be smaller than a predetermined value such that a voltage difference between the second pixel electrode and the third pixel electrode is not zero when the third transistor is turn on, and wherein a scanning process of the corresponding first scanning line of a current pixel-cell row and that of the corresponding second scanning line of a previous pixel-cell begin at the same time, and the previous pixel-cell row is adjacent to the current pixel-cell row and is recently scanned; and
in a 3D display mode, the first scanning line input scanning signals to turn on the first transistor and the second transistor, the first pixel electrode and the second pixel electrode receive the data signals from the data line so as to be in the displaying state of corresponding 3D images, and the second scanning line turns off the third transistor such that the third pixel electrode is in the displaying state of corresponding black images.

2. The array substrate as claimed in claim 1, wherein the array substrate further comprises a switch unit arranged in a periphery of the array substrate and a shorting line, the switch unit comprises a plurality of transistors, each of the transistors comprises a control end, an input end and an output end, each input end of the transistors connects to the corresponding first scanning lines of the current pixel-cell row, each output end of the transistors connects to the corresponding second scanning line of the previous pixel-cell row, the previous pixel-cell row is adjacent to the current pixel-cell row, and each control ends of the transistors connects to the shorting line; and
in the 2D display mode, the shorting line input the control signals to turn on all of the transistors of the switch unit, the scanning signals input by the corresponding first scanning of the current pixel-cell row are simultaneously input to the second scanning line connected to the output end of the corresponding transistor to turn on the third transistor, and in the 3D display mode, the shorting line inputs the control signals to turn off the transistors of the switch unit.

3. The array substrate as claimed in claim 1, wherein a dimension of the third pixel electrode is smaller than the dimension of the first pixel electrode and the second pixel electrode.

4. An array substrate, comprising:
a plurality of first scanning lines, a plurality of second scanning lines, a plurality of data lines, and a plurality of pixel cells, and each the pixel cells corresponds to one first scanning line, one second scanning line, and one data line;
each of the pixel cells comprises a first pixel electrode, a second pixel electrode, a third pixel electrode, a first transistor, a second transistor, and a third transistor, the first pixel electrode connects to the corresponding first scanning line and the corresponding data line via the first transistor, the second pixel electrode connects to the corresponding first scanning line and the corresponding data line via the second transistor, the third pixel electrode connects to the corresponding second scanning line and the second pixel electrode via the third transistor;
in a 2D display mode, the first scanning line inputs scanning signals to turn on the first transistor and the second transistor, the first pixel electrode and the second pixel electrode receive the data signals from the data lines so as to be in a displaying state of corresponding 2D images, the second scanning line inputs the scanning signals to turn on the third transistor such that the second pixel electrode and the third pixel electrode are electrically connected, the third pixel electrode receives the data signals from the second pixel electrode so as to be in the displaying state of corresponding 2D images, the voltage of the second pixel electrode is changed due to the third pixel electrode, the third pixel electrode receives the data signals from the second pixel electrode so as to be in a displaying state of the corresponding 2D images, the voltage of the second pixel electrode is changed due to the third pixel electrode, and a voltage difference between the second pixel electrode and the third pixel electrode is not zero when the third transistor is turn on; and
in a 3D display mode, the first scanning line input scanning signals to turn on the first transistor and the second transistor, the first pixel electrode and the second pixel electrode receive the data signals from the data line so as to be in the displaying state of corresponding 3D images, and the second scanning line turns off the third transistor such that the third pixel electrode is in the displaying state of corresponding black images.

5. The array substrate as claimed in claim 4, wherein the plurality of pixel electrodes, first scanning lines, second scanning lines are arranged along a row direction, in the 2D display mode, and a scanning process of the corresponding first scanning line of a current pixel-cell row and that of the corresponding second scanning line of a previous pixel-cell begin at the same time, and the previous pixel-cell row is adjacent to the current pixel-cell row and is recently scanned.

6. The array substrate as claimed in claim 5, wherein the array substrate further comprises a switch unit arranged in a periphery of the array substrate and a shorting line, the switch unit comprises a plurality of transistors, each of the transistors comprises a control end, an input end and an output end, each input end of the transistors connects to the corresponding first scanning lines of the current pixel-cell row, each output end of the transistors connects to the corresponding second scanning line of the previous pixel-cell row, the previous pixel-cell row is adjacent to the current pixel-cell row, and each control ends of the transistors connects to the shorting line; and
in the 2D display mode, the shorting line input the control signals to turn on all of the transistors of the switch unit, the scanning signals input by the corresponding first scanning of the current pixel-cell row are simultaneously input to the second scanning line connected to the output end of the corresponding transistor to turn on the third transistor, and in the 3D display mode, the shorting line inputs the control signals to turn off the transistors of the switch unit.

7. The array substrate as claimed in claim 4, wherein a dimension of the third pixel electrode is smaller than the dimension of the first pixel electrode and the second pixel electrode.

8. The array substrate as claimed in claim 4, Wherein the third transistor is a thin film transistor (TFT), a width/length ratio of the third transistor is configured to be smaller than a predetermined value such that a voltage difference between the second pixel electrode and the third pixel electrode is not zero.

9. A liquid crystal panel, comprising:
an array substrate, a color filtering substrate and a liquid crystal layer between the array substrate and the color filtering substrate, and the array substrate comprises:
a plurality of first scanning lines, a plurality of second scanning lines, a plurality of data lines, and a plurality of pixel cells, and each the pixel cells corresponds to one first scanning line, one second scanning line, and one data line;
each of the pixel cells comprises a first pixel electrode, a second pixel electrode, a third pixel electrode, a first transistor, a second transistor, and a third transistor, the first pixel electrode connects to the corresponding first scanning line and the corresponding data line via the first transistor, the second pixel electrode connects to the corresponding first scanning line and the corresponding data line via the second transistor, the third pixel electrode connects to the corresponding second scanning line and the second pixel electrode via the third transistor;
in a 2D display mode, the first scanning line inputs scanning signals to turn on the first transistor and the second transistor, the first pixel electrode and the second pixel electrode receive the data signals from the data lines so as to be in a displaying state of corresponding 2D images, the second scanning line inputs the scanning signals to turn on the third transistor such that the second pixel electrode and the third pixel electrode are electrically connected, the third pixel electrode receives the data signals from the second pixel electrode so as to be in the displaying state of corresponding 2D images, the voltage of the second pixel electrode is changed due to the third pixel electrode, the third pixel electrode receives the data signals from the second pixel electrode so as to be in a displaying state of the corresponding 2D images, the voltage of the second pixel electrode is changed due to the third pixel electrode, and a voltage difference between the second pixel electrode and the third pixel electrode is not zero when the third transistor is turn on; and
in a 3D display mode, the first scanning line input scanning signals to turn on the first transistor and the second transistor, the first pixel electrode and the second pixel electrode receive the data signals from the data line so as to be in the displaying state of corresponding 3D images, and the second scanning line turns off the third transistor such that the third pixel electrode is in the displaying state of corresponding black images.

10. The liquid crystal panel as claimed in claim 9, wherein the plurality of pixel electrodes, first scanning lines, second scanning lines are arranged along a row direction, in the 2D display mode, and a scanning process of the corresponding first scanning line of a current pixel-cell row and that of the corresponding second scanning line of a previous pixel-cell begin at the same time, and the previous pixel-cell row is adjacent to the current pixel-cell row and is recently scanned.

11. The liquid crystal panel as claimed in claim 10, Wherein the array substrate further comprises a switch unit arranged in a periphery of the array substrate and a shorting line, the switch unit comprises a plurality of transistors, each of the transistors comprises a control end, an input end and an output end, each input end of the transistors connects to the corresponding first scanning lines of the current pixel-cell row, each output end of the transistors connects to the corresponding second scanning line of the previous pixel-cell row, the previous pixel-cell row is adjacent to the current pixel-cell row, and each control ends of the transistors connects to the shorting line; and
in the 2D display mode, the shorting line input the control signals to turn on all of the transistors of the switch unit, the scanning signals input by the corresponding first scanning of the current pixel-cell row are simultaneously input to the second scanning line connected to the output end of the corresponding transistor to turn on the third transistor, and in the 3D display mode, the shorting line inputs the control signals to turn of the transistors of the switch unit.

12. The liquid crystal panel as claimed in claim 9, wherein a dimension of the third pixel electrode is smaller than the dimension of the first pixel electrode and the second pixel electrode.

13. The liquid crystal panel as claimed in claim 9, wherein the third transistor is a thin film transistor (TFT), a width/length ratio of the third transistor is configured to be smaller than a predetermined value such that a voltage difference between the second pixel electrode and the third pixel electrode is not zero.
